(19) United States
(12) Patent Application Publication
(10) Pub. No.: US 2026/0166922 A1
(43) Pub. Date: Jun. 18, 2026

(54) TIRE TREAD WITH GROOVE HAVING A GROOVE PROJECTION WITH BUMPER

(71) Applicant: COMPAGNIE GENERALE DES ETABLISSEMENTS MICHELIN, Clermont-Ferrand (FR)

(72) Inventors: Tyler SITES, Greenville, SC (US); Terence WALLACE, Greenville, SC (US); Stefan VOSS, Greer, SC (US)

(21) Appl. No.: 19/125,371

(22) PCT Filed: Oct. 31, 2023
(86) PCT No.: PCT/US2023/078264

§ 371 Date: Apr. 29, 2025

Related U.S. Application Data
(60) Provisional application No. 63/384,255, filed on Nov. 18, 2022.

(51) Int. Cl. B60C 11/04; B60C 11/03

(52) U.S. Cl. CPC B60C 11/04; B60C 11/0302; B60C 11/0304; B60C 11/0306; B60C 11/0309; B60C 2011/0381

(57) ABSTRACT

A tire tread is provided that has first and second ribs (30, 34) with first and second rib sidewalls (32, 36). The first rib sidewall and second rib sidewall define a circumferential groove (68). A groove projection (40) is located within the circumferential groove (68), and the groove projection extends for a greater distance in the thickness direction than in the lateral direction. A bumper (42, 62) is present that extends from the groove projection (40), and the groove projection (40) extends for a greater distance in the thickness direction than does the bumper (42, 62).

### FIELD OF THE INVENTION

The subject matter of the present invention relates to a tire tread that has an architectural feature for reducing irregular wear. More particularly, the present application involves a tire tread that has a groove featuring a groove projection that has a bumper extending therefrom.

### BACKGROUND OF THE INVENTION

Manufacturers of heavy commercial vehicle tires have made progress in developing tire architectures and tire materials that allow increase in the wear resistance of tire treads and the reduction of the rolling resistance of tires while at the same time improving their level of grip and resistance to road hazard. Irregular tread wear is a great concern for heavy commercial vehicle tires as it can progressively induce tire vibrations that become sensed by the driver through the steering wheel. It can also make for a poor looking wear pattern. Both of these undesired effects often lead to the tire being removed from service at an early stage of its wear life. Generally, the more the tire is put through a slow-wearing usage, the more irregular wear is affecting the removal mileage. This is why resistance to irregular wear is of paramount importance for truck tires in the so-called long haul steer usage.

It is known to include structural features in tires to fight irregular wear. For example, a sacrificial rib can be incorporated into the tread architecture to delay the onset of irregular wear. One drawback to this design is its susceptibility to aggression damage, specifically cracks that can develop at the bottom of the decoupling groove which may lead to early removal and customer dissatisfaction. It is also known to provide on axle heavy truck tires irregular wear protection by placing within circumferential grooves of the tire a groove projection that is a single stem that extends from the bottom of the circumferential groove. However, irregular wear may be caused at the intersection of the rib surface and the wall of the groove that is generated by edge stresses at this area through contact of the rib. Although mechanisms are known for improving irregular wear for heavy truck tires, there remains room for variation and improvement within the art.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a heavy truck tire.

FIG. 2 is a top view of tread that includes grooves with groove projections and bumpers in accordance with one exemplary embodiment.

FIG. 3 is a cross-section view taken along line 3-3 of FIG. 2.

FIG. 4 is a top view of tread that includes grooves with groove projections and bumpers in accordance with another exemplary embodiment.

FIG. 5 is a cross-section view taken along line 5-5 of FIG. 4.

FIG. 6 is a top view of tread that includes grooves with groove projections and bumpers in accordance with yet another exemplary embodiment.

FIG. 7 is a cross-section view taken along line 7-7 of FIG. 6.

The use of identical or similar reference numerals in different figures denotes identical or similar features.

### DETAILED DESCRIPTION OF THE INVENTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

The present invention provides for a tire tread 16 that has a groove 38 that features a groove projection 40 and a bumper 42 that extends from the groove projection 40. The bumper 42 functions to reduce rib edge stresses by reducing poisson stresses when the bumper 42 comes into contact with either another bumper or a lateral wall 58 of the groove 40. This architecture provides a recessed sacrificial feature within the tread 16 sculpture to increase driving circumferential forces of the ribs to provide irregular wear protection. The bumper 42 can be a continuous bumper 42 along the groove projection 40, and both may extend completely 360 degrees about the central axis 14 of the tire 10.

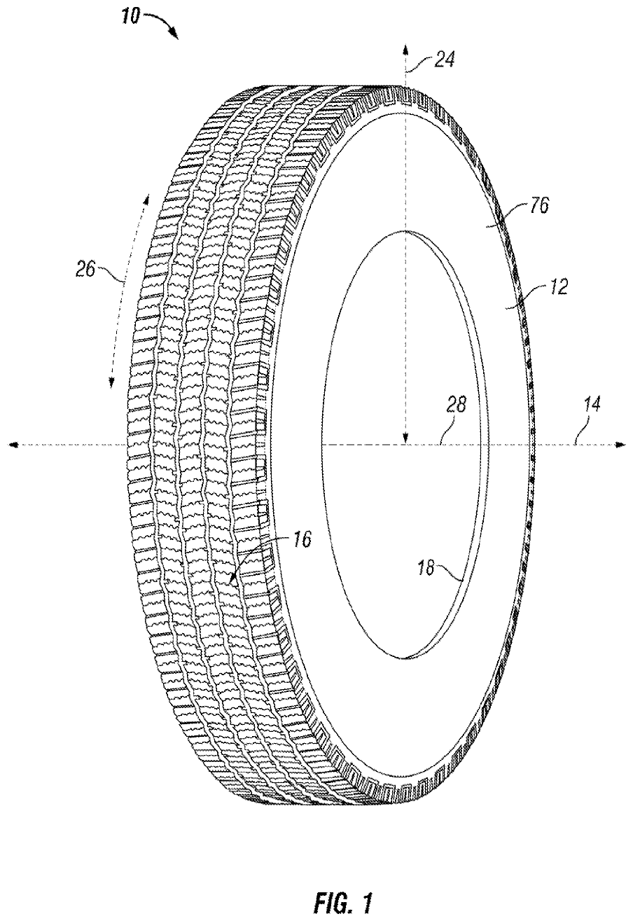

FIG. 1 shows a tire 10 that is a heavy duty truck tire 10. In this regard, the tire 10 is not designed for nor used with a car, motorcycle, or light truck (payload capacity less than 4,000 pounds), but is instead designed for and used with heavy duty trucks such as 18 wheelers, garbage trucks, or box trucks. The tire 10 may be a steer tire, a drive tire, a trailer tire, or an all position tire. The tire 10 includes a casing/carcass 76 onto which a tread 16 is disposed thereon. The central axis 14 of the tire 10 extends through the center of the carcass 76, and the lateral/axial direction 28 of the tire 10 is parallel to the central axis 14. The radial direction 24, which is also known as the thickness direction 24, of the tire 10 is perpendicular to the central axis 14, and the tread 16 is located farther from the central axis 14 in the thickness direction 24 than the carcass 76. The tread 16 extends all the way around the carcass 76 in the circumferential direction 26 of the tire 10 and circles the central axis 360 degrees.

The tread 16 features five ribs that are separated by four longitudinal grooves that extend in the circumferential direction 26. The five ribs can be classified as a central rib, two intermediate ribs, and two shoulder ribs on the ends of the tread 16 in the lateral direction 28. The center and intermediate ribs are continuous and include sipes, and the shoulder ribs are defined by a number of tread blocks from lateral grooves. The longitudinal grooves can be configured in a variety of manners and be of any size or shape. The longitudinal grooves may have a width that is greater than two millimeters. The tread 16 is disposed outboard in the radial direction 24 from a sidewall 12 of the tire, and a pair of beads 18 are near the inner terminal radial end of the sidewall 12. The sipes shown in the tread 16 are cuts into the tread 16 that are two or less millimeters in width.

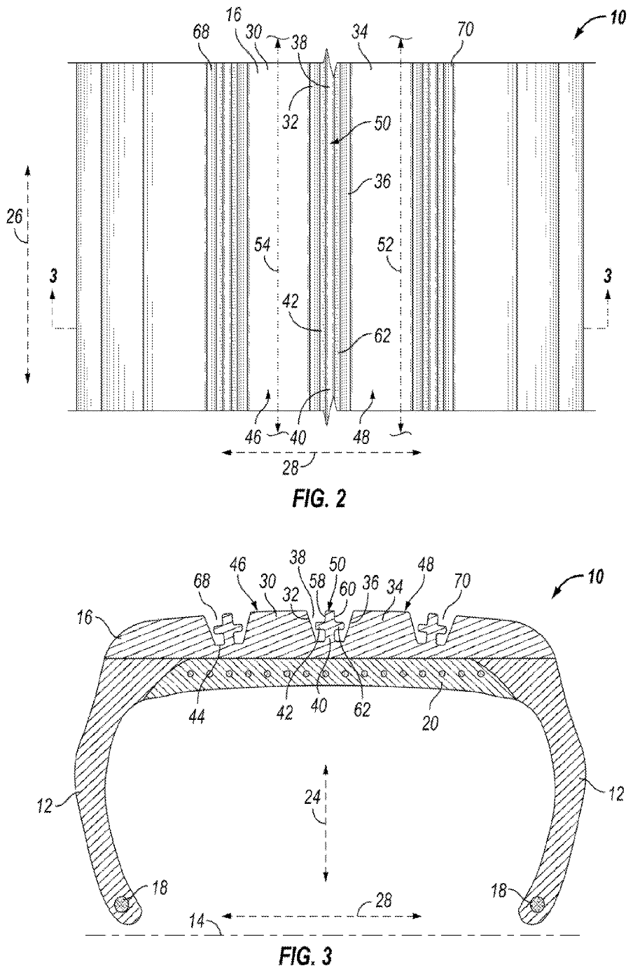

The tread 16 may include certain structural features that can improve irregular wear protection. Turning to FIGS. 2 and 3, a first exemplary embodiment of the heavy truck tire 10 is shown that features three circumferential grooves 38, 68 and 70 and four ribs. The tread 16 rests at least partially on a belt layer 20 that is closer to the central axis 14 in the radial direction 24 than is the tread 16. The first rib 30 has a first rib upper surface 46, and the second rib 34 has a second rib upper surface 48. The groove 38 is a circumferential groove 38 that is located in the center of the tread 16 and can be called a center groove. The first rib 30 has a first rib sidewall 32 that extends from the first rib upper surface 46 into the tread 16, and the second rib 34 has a second rib sidewall 36 that also extends into the tread 16 from the second rib upper surface 48. The two sidewalls 32, 36 extend to a groove bottom 44, and the circumferential groove 38 can be defined by the two sidewalls 32, 36 and the groove bottom 44.

The groove projection 40 is a portion of the tread 16 that extends from the groove bottom 44 outward in the thickness direction 24 from the central axis 14. In this embodiment, the groove projection 40 does not engage the first rib sidewall 32 or the second rib sidewall 36. The groove projection 40 terminates at a groove projection upper surface 50. In some embodiments, the groove projection upper surface 50 is located the same distance from the central axis 14 in the thickness direction 24 as is the first rib upper surface 46 and the second rib upper surface 48. In other embodiments, the groove projection upper surface 50 is located closer to the central axis 14 in the thickness direction 24 than are the first and second upper rib surfaces 46, 48. As the heavy duty truck tire 10 rotates, the groove projection upper surface 50 may engage the surface of the road.

The groove projection 40 may be of any shape and size and may fill a majority of the volume of the circumferential groove 38. The groove projection 40 has first and second lateral sidewalls 58, 60 in which the first lateral sidewall 58 directly faces the first rib sidewall 32, and in which the second lateral sidewall 60 directly faces the second rib sidewall 36. These lateral walls 58, 60 extend from the groove bottom 44 to the groove projection upper surface 50. The lateral walls 58, 60 taper inwards towards one another in the lateral direction 28 upon their extension outward in the thickness direction 24, but could not taper in other embodiments. The bumpers 42, 62 extend from the lateral walls 58, 60. The bumper 42 could be referred to as a first bumper 42 which extends from the first lateral wall 58 and directly faces the first rib sidewall 32, and the second bumper 62 extends from the second lateral wall 60 and directly faces the second rib sidewall 36. The bumpers 42, 62 are spaced in the thickness direction 24 and are free from engagement with the groove projection upper surface 50 and the groove bottom 44. The bumpers 42, 62 are sized and shaped the same, but could be differently sized and/or shaped in other embodiments. The groove projection 40 extends for a greater distance in the thickness direction 24 than the bumpers 42, 62 extend in the thickness direction 24. The bumpers 42, 62 may extend completely in the lateral direction 28 such that their upper and lower surfaces do not change positions in the thickness direction 24 at any point.

The groove projection 40 has a circumferential length 54 that extends completely around the entire tire 10 in the circumferential direction 26 so that it extends 360 degrees about the central axis 14. The bumper 42 has a circumferential length 52 that likewise extends completely around the entire 10 in the circumferential direction 26 so that it extends 360 degrees about the central axis 14. The second bumper 62 may also have the same circumferential length as the circumferential length 52. The circumferential lengths 52, 54 may be continuous so that the groove projection 40 and the bumpers 42, 62 are completely continuous and are not discontinuous at any point along the circumferential lengths 52, 54. The groove projection 40 and bumpers 42, 62 may have the same cross-sectional size and shape along the entire circumferential lengths 52, 54 and not change at any point.

The tread 16 in FIGS. 2 and 3 includes three circumferential grooves 38, 68 and 70 and the second and third circumferential grooves 68, 70 could likewise include a groove projection 40 and bumpers 42, 62. These components 40, 42, 62 can be configured in the same way as previously discussed and a repeat of this information is not necessary. As such the size and shape of the circumferential grooves 38, 68, 70 and the components 40, 42, 62 in them may be identical. However, the tread 16 may include grooves 38, 68, 70 and components 40, 42, 62 that are different from one another in other embodiments. The ribs 30, 34 and the two shoulder ribs are not blocky and do not have any grooves in them such that they are essentially continuous and uninterrupted completely about the central axis 14.

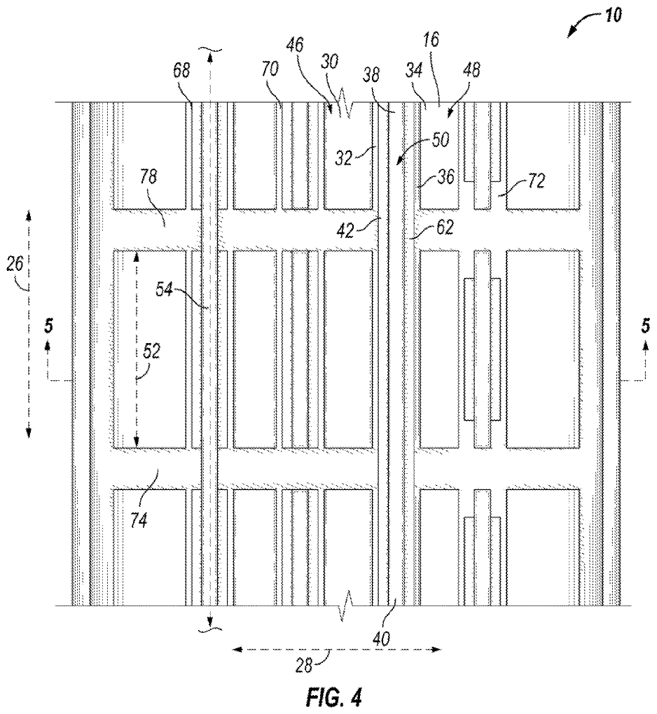

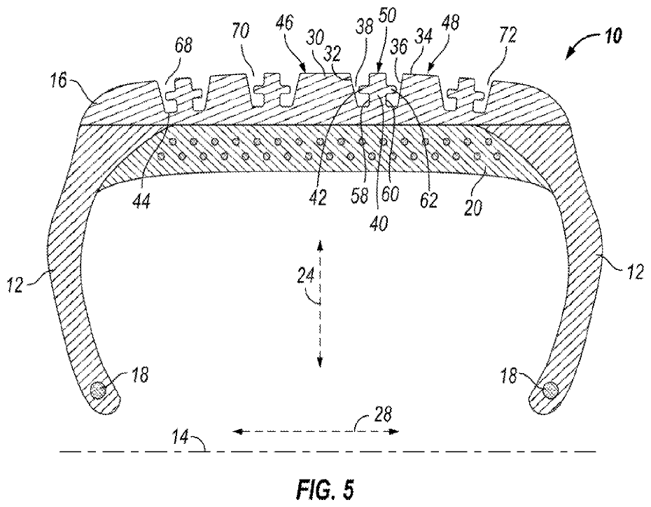

During driving of the tire 10, the circumferential groove 38 can become deformed in the contact patch from that of the non-contact patch configuration as shown in FIGS. 3 and 4. In this regard, the groove projection 40, bumpers 42 and 62, and/or rib sidewalls 32 and 36 can become deformed such that the bumper 42 engages the first rib sidewall 32 and such that the second bumper 62 engages the second rib sidewall 36. This engagement reduces first and second rib 30, 34 edge stresses by reducing the poisson stresses at their engagement with the rib sidewalls 32, 36. With reference to FIG. 3, the first rib 30 edge stress occurs at the intersection between the first rib 30 and the first rib sidewall 32, and the contact between the first bumper 42 and the first rib sidewall 32 reduces the poisson stress at this point and reduces irregular wear initiation at this location. In a similar fashion, contact between the second bumper 62 and the second rib sidewall 36 reduces poisson stresses that would otherwise be present at the intersection between the second rib 34 and the second rib sidewall 36. These reductions in poisson stress reduce irregular wear initiation experienced on the tread 16. The groove projection 40 and bumper 42, 62 arrangement increase the profile and provides a recessed sacrificial feature with the tread 16 sculpture to increase the tendency to driving circumferential forces of the main ribs of the tread 16 to provide irregular wear protection.

Another exemplary embodiment of the tire tread 16 is shown with reference to FIGS. 4 and 5. The tread 16 is a five rib design with four circumferential grooves. The grooves are identified as the first circumferential groove 38, the second circumferential groove 68, the third circumferential groove 70, and the fourth circumferential groove 72. The first circumferential groove 38 has a groove projection 40 and bumpers 42, 62 that are arranged in a similar manner as previously discussed with respect to the embodiment in FIGS. 2 and 3 and a repeat of this information is not necessary. The embodiment in FIGS. 4 and 5 differs in that the circumferential lengths of the components are different between the groove projections 40 and bumpers 42, 62 of the various circumferential grooves 38, 68, 70, 72. With respect first to the first circumferential groove 38, the projection 40 and bumpers 42, 62 are all completely continuous 360 degrees in the circumferential direction 26 about the central axis 14. The circumferential lengths 52 and 54 are the same as one another.

The tread 16 features lateral grooves 74, 78 that extend completely across the lateral width of the tread from one side edge to the other. All of the ribs 30, 34 are block type ribs due to the presence of the lateral grooves 74, 78. The second circumferential groove 68 features a projection 40 that, again like the projection 40 in the first circumferential groove 38, extends completely and continuously 360 degrees about the central axis 14. However, the bumpers 42, 62 are not completely continuous in the circumferential direction 26 but are discontinuous. The bumpers 42, 62 are present at locations in the circumferential direction 26 that are not at the same locations in the circumferential direction 26 that the lateral grooves 74, 78 are located. The circumferential length 52 is less than the circumferential length 54. The locations in the circumferential direction 26 that are common to both the second circumferential groove 68 and the lateral grooves 74, 78 include the groove projection 40 but do not include the bumpers 42, 62 in the second circumferential groove 68. The bumpers 42, 62 are present at areas in the second circumferential groove 68 that have lateral walls 58, 60 directly facing them in the lateral direction 28, and not in areas that have space from the lateral grooves 74, 78 opposite in the lateral direction 28.

The third circumferential groove 70 has component 40, 42, 62 lengths that are different than those in both the first circumferential groove 38 and the second circumferential groove 68. Here, the bumpers 42, 62 are present only in areas of the third circumferential groove 70 that do not share the same locations in the circumferential direction 26 as the lateral grooves 74, 78. Additionally, the groove projection 40 does not extend completely 360 degrees around the central axis 14 in the circumferential direction 26. Instead, the groove projection 40, like the bumpers 42, 62, is discontinuous at locations in the circumferential direction 26 that are the same as those shared by the lateral grooves 74, 78. The groove projections 40 and bumpers 42, 62 are discontinuous at various locations around the tire 10 in the circumferential direction 26.

A fourth circumferential groove 72 is present in the tread 16 and again features the groove projection 40 and bumpers 42, 62 with a cross-section and shape that are the same as those in the rest of the tread 16. The groove projection 40 extends completely around the tire 10 in the circumferential direction 26, but is discontinuous at the lateral grooves 74, 78. In this regard, the groove projection 40 of the fourth circumferential groove 72 is not present at locations in the circumferential direction 26 that are common to the lateral grooves 74, 78. The bumpers 42, 62 are also not present at circumferential locations common to the lateral grooves 74, 78. Additionally, the bumpers 42, 62 do not have the same lengths in the circumferential direction 26 as does the groove projection 40. In this regard, the bumpers 42, 62 are spaced in the circumferential direction 26 from the lateral grooves 74, 78 and are equal distance before they start.

It is to be understood that the groove projections 40 and bumpers 42, 62 may all be arranged in the same manner as one another, or some could be the same while others are different. In the FIGS. 4 and 5 embodiment, each one of the circumferential grooves 38, 68, 70, 72 has groove projections 40 and bumpers 42, 62 arranged in a different manner with respect to their lengths in the circumferential direction 26. However, the cross-sectional features of the groove projections 40 and bumpers 42, 62 are the same as one another, and are also the same as those previously discussed with respect to the FIGS. 2 and 3 embodiment.

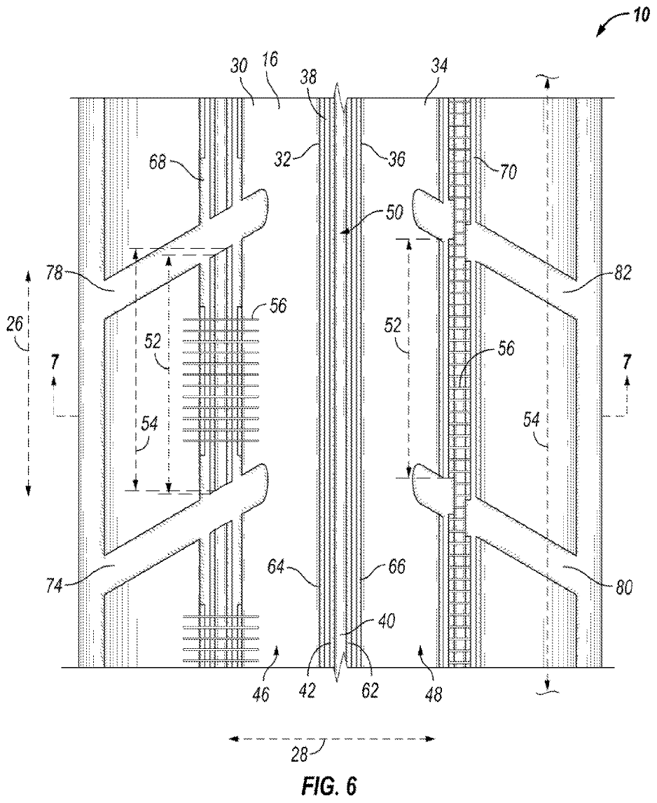

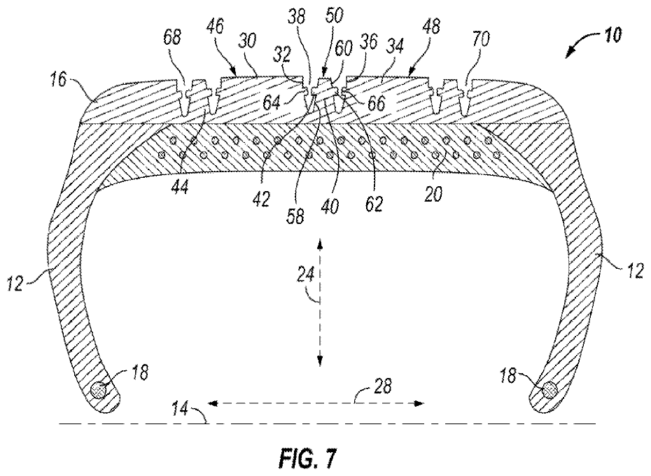

Another exemplary embodiment of the tire 10 is shown in FIGS. 6 and 7 in which the tread 16 has four ribs and three circumferential groove 38, 68 and 70. Four lateral grooves 74, 78, 80 and 82 extend inboard in the lateral direction 28 and are blind grooves in that they terminate within the tread 16. The lateral grooves 74, 78 intersect only the second circumferential groove 68, the lateral grooves 80, 82 intersect only the third circumferential groove 70, and the first circumferential groove 38 is not intersected by any lateral groove. The lateral grooves 74, 78, 80 and 82 are angled in that they extend in both the lateral 28 and circumferential 26 directions from the tread edges. The groove projection 40 has a length in the thickness direction 24 such that the groove projection upper surface 50 is closer to the central axis 14 in the thickness direction 24 than the distance in the thickness direction 24 of the first and second rib upper surfaces 46, 48 to the central axis 14. The first and second rib upper surfaces 46, 48 are outward in the thickness direction 24 from the groove projection upper surface 50 which is inset into the circumferential groove 38. First and second bumpers 42 and 62 are present and extend from the lateral walls 58 and 60. The circumferential groove 38 does not have a groove bottom 44, but instead the groove projection 40 extends upwards from the first and second rib sidewalls 32 and 36 which engage the groove projection 40.

A third bumper 64 is present and extends from the first rib sidewall 32, and a fourth bumper 66 extends from the second rib sidewall 36. The first rib sidewall 32 extends only in the thickness direction 24 from the first rib upper surface 46 to the third bumper 64, and extends in both the lateral 28 and thickness 24 directions from the third bumper 64 to the groove projection 40. Also, the second rib sidewall 36 extends only in the thickness direction 24 from the second rib upper surface 48 to the fourth bumper 66, and extends in both directions 24, 28 from the fourth bumper 66 to the groove projection 40. The third and fourth bumpers 64, 66 are spaced from the rib upper surfaces 46, 48 in the thickness direction 24, and do not engage the groove projection 40. The first and third bumpers 42 and 64 may share the same position in the thickness direction 24, and the second and fourth bumpers 62 and 66 share the same position in the thickness direction 24.

The groove projection 40 and bumpers 42, 62, 64, 66 in the first circumferential groove 38 extend continuously and completely about the central axis 14 in the circumferential direction 26. The second circumferential groove 68 has a groove projection 40 that is discontinuous at the lateral grooves 74 and 78 such that it is not present at these locations. The first and second bumpers 42 and 62 are likewise discontinuous at the lateral grooves 74 and 78 and not present at these locations, but with the groove projection 40 is present at the other locations about the circumference of the tire 10 that do not have such lateral grooves. The third and fourth bumpers 64, 66 are likewise not present at the lateral groove 74, 78 locations, but are also spaced from these lateral grooves 74, 78 in the circumferential direction 28. From the lateral groove 74 to the lateral groove 78, the circumferential lengths of the third and fourth bumpers 64, 66 are less than the circumferential lengths of the groove projection 40 and the first and second bumpers 42, 62. Also from the lateral groove 74 to the lateral groove 78, the circumferential lengths of the groove projection 40 and first and second bumpers 42, 62 are the same although they are offset from one another. Sipes 56 are present in the area of the second circumferential groove 68 such that the sipes 56 extend into the shoulder rib and first rib 30, and completely through the groove projection 40, sidewalls 32 and 36, and bumpers 42, 62, 64 and 66.

The third circumferential groove 70 is intersected by lateral grooves 80 and 82 that extend in the lateral and circumferential directions 28 and 26. The lateral grooves 80 and 82 extend into and terminates within the second rib 34. The groove projection 40 is uninterrupted and extends completely around the central axis 14 in the circumferential direction 26. The first and second bumpers 42 and 62 are discontinuous at the positions in the circumferential direction 26 common to the lateral grooves 80 and 82, although some small amount of the bumpers 42 and 62 may extend into the lateral grooves 80 and 82 and share some amount of common circumferential positioning. The length 54 is longer than the length 52. The third and fourth bumpers 64 and 66 extend the same amount in the circumferential direction 26 as do the first and second bumpers 42 and 62 and share the same positioning in the circumferential direction 26 as do the first and second bumpers 42 and 62. Sipes 56 may be present in the third circumferential groove 70 and may extend completely through the groove projection 40 and the first bumper 42 and second bumper 62. The sipes 56 are not present in the second rib 34, shoulder rib, or the third and fourth bumpers 64 and 66.

The groove bottom 44 is not present, and instead the first and second rib sidewalls 32 and 36 engage the groove projection 40. In use, the circumferential groove 38 will deform such that the first bumper 42 engages the third bumper 64, and such that the second bumper 62 engages the fourth bumper 66 to reduce contact poisson stresses and reduce irregular wear initiation. The bumpers 42, 62, 64, 66 are located closer to the central axis 14 in the thickness direction 24 than the upper rib surfaces 46, 48 and groove projection upper surface 50 are to the central axis 14 in the thickness direction 24.

The three circumferential grooves 38, 68, and 70 all have different configurations of the lengths of the various components. However, all of the circumferential grooves 38, 68 and 70 may be configured the same in other exemplary embodiments. In yet other arrangements, some of the circumferential grooves can be the same and others unique in configuration in the tread 16. The various configurations in the different exemplary embodiments of the circumferential grooves shown herein can be used in any combination to result in different tread 16 configurations.

The tire 10 configurations herein increase irregular wear protection without detracting from other performance areas of the tread 16. Various embodiments of the tire 10 do not include sacrificial ribs on the tread 16 since irregular wear protection can be achieved with the disclosed features. Since sacrificial ribs need not be present in these embodiments, the problems associated with sacrificial ribs, such as cracking at the bottom of the decoupling groove, can be avoided with the present design. In this regard, the sacrificial rib is a rib located the most outboard in the lateral direction 28 and has a height lower than the remaining ribs in the thickness direction 24. The groove projection 40 could be described as a sacrificial feature/rib, but it is to be understood that in the context of not having a sacrificial rib, the tread 16 lacks the lower ribs on either end of the tread 16 in the lateral direction 28. The shapes, sizes, and designs of the groove projections 40, and bumpers 42, 62, 64, 66 are only exemplary and others can be used such that these components can be variously shaped, sized, and designed in accordance with different exemplary embodiments. The bumpers 42, 62, 64, 66 can be longer in the lateral direction 28 than the thickness direction 24, can be longer in the thickness direction 24 than in the lateral direction 28, or may be the same lengths in both the lateral and thickness directions 28, 24. The bumpers 42, 62, 64, 66 may all be shorter in length in the thickness direction 24 than the groove projection 40 is in the thickness direction 24. Further, although shown as being present within all of the grooves 38, the groove projections 40 and bumpers 42, 62, 64, 66 can be present in one or some of the grooves 38 of the tread 16 and not present in others.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

1. A tire tread that has a lateral direction, a thickness direction, and a circumferential direction, comprising:
a first rib having a first rib sidewall;
a second rib having a second rib sidewall, wherein the first rib sidewall and the second rib sidewall define a circumferential groove;
a groove projection that is located within the circumferential groove, wherein the groove projection extends for a greater distance in the thickness direction than in the lateral direction, wherein the groove projection has a groove projection upper surface;
a groove bottom that engages both the first rib sidewall and the second rib sidewall, wherein the groove projection extends in the thickness direction from the groove bottom; and
a bumper that extends from the groove projection, wherein the groove projection extends for a greater distance in the thickness direction than does the bumper, wherein the bumper is spaced from and is free from engagement with the groove projection upper surface, the groove bottom, the first rib sidewall, and the second rib sidewall.

2. The tire tread as set forth in claim 1, wherein the groove projection is spaced from and free from engagement with both the first rib sidewall and the second rib sidewall.

3. The tire tread as set forth in claim 1, wherein the first rib has a first rib upper surface and wherein the second rib has a second rib upper surface; and
wherein the first rib upper surface, the second rib upper surface, and the groove projection upper surface are all located at the same position in the thickness direction.

4. The tire tread as set forth in claim 1, wherein the bumper is continuous along the groove projection such that a circumferential length of the bumper is the same as a circumferential length of the groove projection.

5. The tire tread as set forth in claim 4, wherein the circumferential length of the bumper and the circumferential length of the groove projection extend 360 degrees about a central axis.

6. The tire tread as set forth in claim 4, wherein the circumferential length of the bumper and the circumferential length of the groove projection extend less than 360 degrees about a central axis.

7. The tire tread as set forth in claim 1, such that a circumferential length of the groove projection extends 360 degrees about a central axis, and wherein the bumper is discontinuous along the groove projection in the circumferential direction.

8. The tire tread as set forth in claim 1, wherein a circumferential length of the bumper is less than a circumferential length of the groove projection.

9. The tire tread as set forth in claim 1, wherein the first rib has a first rib upper surface and wherein the second rib has a second rib upper surface;
wherein the bumper is spaced from the first rib upper surface, the second rib upper surface, and the groove projection upper surface in the thickness direction such that the bumper is located closer to a central axis in the thickness direction than are the first rib upper surface, the second rib upper surface, and the groove projection upper surface are to the central axis in the thickness direction.

10. The tire tread as set forth in claim 1, wherein the bumper is longer in the lateral direction than in the thickness direction.

11. The tire tread as set forth in claim 1, further comprising a plurality of sipes that are located in both the groove projection and the bumper.

12. The tire tread as set forth in claim 1, wherein a sacrificial rib is not present in the tire tread.

13. The tire tread as set forth in claim 1, wherein the groove projection has a first lateral wall and a second lateral wall spaced from the first lateral wall in the lateral direction, wherein the bumper is a first bumper that extends from the first lateral wall; and
further comprising a second bumper that extends from the second lateral wall, wherein the groove projection extends for a greater distance in the thickness direction than does the second bumper.

14. The tire tread as set forth in claim 13, further comprising:
a third bumper that extends from the first rib sidewall, wherein the groove projection extends for a greater distance in the thickness direction than does the third bumper; and
a fourth bumper that extends from the second rib sidewall, wherein the groove projection extends for a greater distance in the thickness direction than does the fourth bumper.

15. The tire tread as set forth in claim 1, wherein the tire tread is on a long haul heavy truck steer tire.
